(19) United States
(12) Patent Application Publication
(10) Pub. No.: US 2010/0049703 A1
(43) Pub. Date: Feb. 25, 2010

(54) METHOD FOR SUMMARISING KNOWLEDGE FROM A TEXT

(76) Inventor: Enrico Coiera, Queens Park (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/916,442

(22) PCT Filed: Jun. 2, 2006
(86) PCT No.: PCT/AU06/00739

§ 371 Date: Dec. 3, 2007

(30) Foreign Application Priority Data
Jun. 2, 2005 (AU) 2005092860

(51) Int. Cl. G06F 17/30

(52) U.S. Cl. 707/5; 707/E17.015

(57) ABSTRACT

The present invention relates to a method for summarising knowledge from text and in particular to a method and system for summarising knowledge from text such as scientific or research papers. The continuing growth of the published literature has created a fundamental barrier to the transfer of what is published being used in common practice. There is just too much literature for human beings to deal with. The present invention provides a computing system and method for automatically summarising knowledge from text, by determining some concepts from the text, generating a set of candidate relationships between the concepts, generating a set of relationships based on the set of candidate relationships according to predetermined criteria and generating a decision model based on the set of relationships.

### TECHNICAL FIELD

This invention relates to a method and system for summarising knowledge from a text.

### BACKGROUND TO THE INVENTION

The continuing growth in the published literature has created a fundamental barrier to the transfer of what is published being used into common practice. For example, the number of scientific articles in existence doubles at 1- to 15 year intervals, depending on the scientific discipline, and a new article is added to the medical literature every 26 seconds or less. As a consequence the growth in the literature is exponential. In one study of the literature related to a single clinical disease over 110 years, it was found that only 3% of the literature had been generated in the first 50 years, and 40% had been generated in the last 10 years. Consequently, it may no longer be possible to simply keep ‘up-to-date’ by reading the latest literature from time to time, as the volume of published material exceeds human limits to read or understand it all.

In order to address the above problem it has been tried to compile the information contained within a number of documents to synthesise a summary of the core information so that an individual need only access the summary rather than all of the documents that were used to generate it. For example, with the growth in the biomedical knowledge base, it is increasingly hard for health care practitioners to understand what the current published literature indicates would be best practice, as there is insufficient human resource to read all these documents and come up with simple recommendations about current best-practice. At present, the task of synthesis is manual. While the volume of clinical research that forms the core of our evidence-base is growing exponentially, the human resources that can be devoted to activities that synthesise and summarise knowledge, such as guideline creation, are at best relatively fixed. For groups devoted to manual synthesis, it suggests that by using current manual methods, over time they will have insufficient resources to synthesise even a small fraction of the evidence into critical reviews or guidelines. Further, individual systematic reviews will take progressively longer to complete as the evidence-base that needs to be considered grows, resulting in delays in publication of new critical reviews.

### SUMMARY OF THE INVENTION

In a first aspect the present invention provides a method of summarising knowledge from a text including the steps of:

determining some concepts from the text;
generating a set of candidate relationships between the concepts;
generating a set of relationships based on the set of candidate relationships according to predetermined criteria; and
generating a decision model based on the set of relationships.

The step of determining some concepts from the text may farther include the step of identifying some terms in the text and determining concepts for at least some of the terms.

The step of identifying terms in the text may include the step of searching the text for terms matching a pre-defined set of terms.

The step of determining concepts may include the step of looking up possible concepts from a look up table of terms and concepts.

The step of generating a set of candidate relationships may be based on relationships that are common to the field of the subject matter to which the text relates.

The predetermined criteria may include removing a candidate relationship that is implausible according to relationship constraint rules.

The predetermined criteria may include retaining a candidate relationship that is supported by evidence in the text.

The predetermined criteria may include modifying a candidate relationship if it is determined to be incorrect.

The predetermined criteria may include inferring a candidate relationship if it is determined to be missing.

The method may further include the step of testing the decision model for internal consistency.

The method may further include the step of combining the decision model with other decision models derived from other texts.

In a second aspect the present invention provides a computing system configured to conduct the method of the first aspect of the invention.

In a third aspect the present invention provides a computer program arranged to cause a computing system to conduct a method according to the first aspect of the invention.

In a fourth aspect the present invention provides a system for summarising knowledge from a text, the system including: determining means for determining some concepts from the text; means for generating a set of candidate relationships between the concepts; means for generating a set of relationships based on the set of candidate relationships according to predetermined criteria, and means for generating a decision model based on the set of relationships.

In an embodiment, the determining means is arranged to identify some terms in the text and determine concepts for at least some of the terms.

In an embodiment, the determining means is arranged to identify terms in the text by searching the text for terms matching a pre-defined set of terms.

In an embodiment, the system includes a look-up table of terms and concepts, and the determining means is arranged to look up possible concepts from the look-up table.

In accordance with an embodiment, the means for generating a set of candidate relationships is arranged to determine the relationships from relationships that are common to the field of the subject matter to which the text relates.

In an embodiment, the predetermined criteria may include removing a candidate relationship that is implausible according to relationship constraint rules.

In an embodiment, the predetermined criteria may include retaining a candidate relationship that is supported by evidence in the text.

In accordance with an embodiment, the predetermined criteria may include modifying a candidate relationship if it is determined to be incorrect.

In an embodiment, the predetermined criteria may include inferring a candidate relationship if it is determined to be missing.

In accordance with an embodiment, the system further includes a testing means for testing the decision model for internal consistency.

In accordance with an embodiment, the system includes a combination means for combining the decision model with other decision models derived from other texts.

In the above aspects of the invention, a decision model is generated. In other embodiments of the present invention, other types of summaries other than decision models may be prepared.

In a fifth aspect, the present invention provides a method of summarising knowledge from a text including the steps of:

determining some concepts from the text;

generating a set of candidate relationships between the concepts;

generating a set of relationships based on the set of candidate relationships according to predetermined criteria; and

generating a summary based on the set of relationships.

In a sixth aspect, the present invention provides a system for summarising knowledge from a text, the system including: determining means for determining some concepts from the text; means for generating a set of candidate relationships between the concepts; means for generating a set of relationships based on the set of candidate relationships according to predetermined criteria, and means for generating a summary based on the set of relationships.

### BRIEF DESCRIPTION OF THE DRAWINGS

An embodiment of the present invention will now be described, by way of example only, with reference to the accompanying drawings, in which:

FIG. 1 depicts a schematic representation of a computer system suitable for use in an embodiment of the invention; and

FIG. 2 depicts an example of a decision tree produced by an embodiment of the invention.

### DETAILED DESCRIPTION OF THE PREFERRED EMBODIMENT

In this embodiment the method of the invention is conducted by a computing system to automatically extract the core findings of a scientific paper known as a randomised controlled trial (RCT), which is a typical way of reporting the results of a scientific study in the biomedical literature. The method could be applied however to many different types of document, and is not limited to RCTs. The extracted and summarised knowledge is represented as a decision tree, although again any relevant form of knowledge representation could be chosen to represent the summarised knowledge, and this method is not limited to decision trees alone.

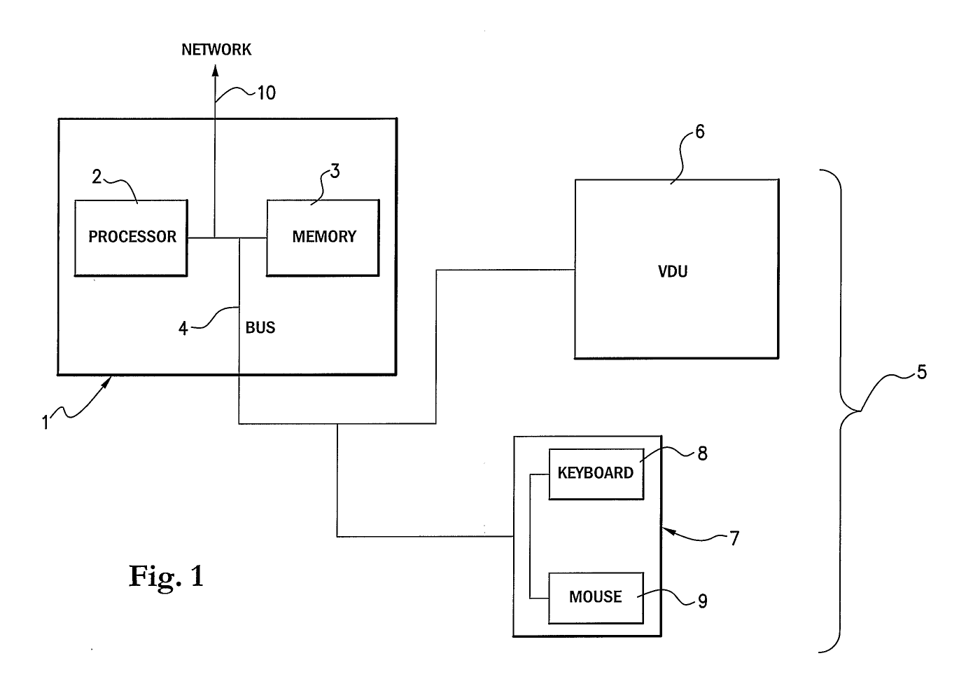

Referring to FIG. 1, a computing system 1 is shown including a processor 2, and memory 4 linked by bus 4. Input and output devices 5 are shown in the form of VDU 6, keyboard 8 and mouse 9. Computing system 1 is connected to a network 10. Computing system 1 is loaded with software that causes the computing system to conduct the method discussed below.

1. The system takes as input the text from a document.
2. The system systematically searches the document text and creates a list of all recognisable individual words or phrases. The system has access to an electronic nomenclature, representing the vocabulary associated with this domain, and seeks words in the text document that are present in the nomenclature. In the biomedical literature, one could use the Unified Medical Language System or UMLS, which is a comprehensive and hierarchically structured representation of the concepts associated with medical language, and a representation of the common synonyms for each concept. Other internationally recognised nomenclatures include SNOMED CT and ICD-10. For phrase matching, standard pattern recognition algorithms are used to determine the degree of statistical match between a phrase in the text document and a concept or collection of concepts in nomenclature. For example, the UMLS provides the publicly available algorithm MMTX to identify words or phrases in a block of text that match concepts within its dictionaries. For example, such an algorithm might read the sentence “There is good evidence that low dose aspirin can reduce the incidence of deep vein thrombosis on long haul flight” and generate the following list of word and phrase candidates as matches within its nomenclature [aspirin, “low dose aspirin”, vein, thrombosis, “deep vein thrombosis”, flight, “long haul flight”].
3. The list of individual words or phrases that match concepts in the nomenclature becomes a list of CANDIDATE TERMS. For each candidate term, we next create a list of all the CANDIDATE CONCEPTS each term matches in the nomenclature. For example the word ‘aspirin’ would match the concept of aspirin in UMLS, which is identified as a pharmaceutical agent, and ‘vein’ would be identified with the concept ‘vein’ in UMLS, which is in the body part hierarchy of the nomenclature. Some words or phrases may be ambiguous and return more than one match. For example ‘ventricle’ may match either the concept of an anatomical chamber of the heart or an anatomical structure in the brain.
4. Having identified the CANDIDATE CONCEPTS from within the text, the next stage is to extract from the document any knowledge about how the document discusses the relationships between the concepts. Within a specific domain eg engineering, dentistry or medicine, a document will discuss the relationships between concepts using a common set of relationships particular to the domain. For example, in a scientific paper that reports the efficacy of a new medication, the typical relationships between two concepts might include ‘treats’, ‘causes’, ‘is a side-effect of’, and so forth. Thus, a list RELATIONSHIP TYPES specific to the domain is developed. Using both the database of relationship types for the domain, and the list of Candidate concepts prepared from the text document, every possible permutation of terms and relationships is generated. For example we would create the possible relationships “aspirin treats deep vein thrombosis” and “aspirin causes vein”. This list of all possible permutations becomes the CANDIDATE RELATIONSHIPS arising out of the text document.
5. Many of the candidate relationships will be implausible, and these implausible relationships are detected and removed. For this purpose, we use a database of RELATIONSHIP CONSTRAINT RULES, which define allowable relationships. For example, constraint rules may describe legitimate relationships based on the typing of terms. Thus, the relationship type ‘X treats Y’ may have an associated relationship constraint rule “DRUG treats DISEASE”, which in effect says that for X to be a plausible treatment of Y, Y must be a disease, and X needs to be a drug. A plurality of such rules may exist for any given relationship, as more than one concept type may be allowed. For example, we know that surgery is also a type of treatment for diseases. Having access to a set of constraint rules, we next filter all the implausible candidate relationships generated in the previous step. In this example, the candidate relationship “aspirin treats deep vein thrombosis” would match this rule as aspirin is a DRUG and ‘deep vein thrombosis’ is a disease. In contrast, “aspirin treats vein” does not match the rule. The filtering step removes candidate relationships that do not satisfy one of a possible plurality of satisfaction criteria. For example, a criterion may be that a candidate relationship must match at least one constraint rule. The actual criteria for matching constraint rules and candidate relationships can vary, depending upon the noise in the text data, and the degree of match can be tailored to be very tight or quite loose, depending upon the domain of application.
6. The previous steps have resulted in a list of plausible relationships that might be discussed in a document, based solely on the concepts found in the document, and knowledge of the likely relationships any document in the domain might discuss. In the next step, we seek specific evidence for the surviving list of candidate relationships within the text of the document in question. In this step, we again attempt to filter the list down to a smaller candidate list, removing those relationships for which there is no support at all within the text. To do this we apply rules from a database of TEXT PROCESSING RULES. For example, a text-processing rule may take advantage of the text documents structure as well as the words appearing in a given sentence. Various document mark-up languages exist including XML and HTML. For example, we may have the candidate relationship ‘aspirin treats thrombosis’ and look to the text processing rules in our database for rules that could be applied to provide evidence that this relationship is discussed in the text document. Such a rule from a plurality of possible rules might retrieve the words in the section of a document marked-up as the title of the document and then search for evidence of a ‘treats’ relationship by looking for the phrases ‘Effect of X’ and ‘on Y’. A text document title “A randomised trial to test the effect of aspirin on deep vein thrombosis” would match this rule, and provide support for the candidate relationship. Many such rules could be created to look for alternate ways of stating the relationship in a text document. Such rules may be arbitrarily complex, and use the full power of an expressive language such as first-order logic to describe relationships between words and phrases in text and candidate relationships. This filtering step again removes candidate relationships that do not satisfy one of a possible plurality of satisfaction criteria. For example, a criterion may be that a candidate relationship must match at least one text-processing rule. The actual criteria for matching text processing rules and candidate relationships can vary, depending upon the noise in the text data, and the degree of match can be tailored to be very tight or quite loose, depending upon the domain of application. At the completion of this step, every member of the candidate relationship list has been tested, and only those candidate relationships that have satisfied the satisfaction criteria for matching text rules to the document text are retained.
7. Further iterations of the previous steps may now be undertaken to extract more details about any individual candidate relationship, characterising the relationship by a further set of propositions, which may be in the form of additional relationships, using a plurality of other relationship types, constraint and text processing rules. The process may iterate on any further such candidates discovered in such subsequent steps. By way of example, in a text article describing a randomised controlled trial of a medication called Med, we may have a candidate relationship that ‘Med causes skin rash’ which is a side-effect of the drug described in the text. We may now seek to extract more information about this relationship using additional rules. For example, a text-processing rule may identify that of 500 patients given the drug, 25 developed the skin rash, to generate the proposition ‘Med causes skin rash in 25/500 patients’.
8. At this stage we now have a collection of candidate relationships, which collectively represent propositions about the content of the text document. The next stage in the knowledge extraction process is to assemble these propositions, howsoever defined, into coherent models or explanations. For example, one knowledge representation method is to assemble antecedents, consequents and choices as a decision tree. However this method may use any appropriate knowledge representation method, and is not limited to decision trees. Alternate representations include, but are not limited to, representations of actions such as plans, of which there are many formalisms, belief or Bayesian networks, qualitative differential equations etc. By way of example only, we now demonstrate how the candidates can be assembled into a decision tree. Assume we have the following list of candidate relationships: x treats y, a treats y, x causes z and x causes m. We can simply assemble these propositions into a larger network that corresponds to a decision tree. With a large number of propositions, a plurality of trees might be generated if there is ambiguity. It may also be the case that several independent trees are generated, as the text has described separate concepts. We now label each of these candidate trees as members of a set of CANDIDATE DECISION TREES. If alternate representations were used instead of decision trees, then the alternate assemblies would form a set of candidate models.
9. The final stage in the process tests each candidate model for internal consistency, as some assemblies may be syntactically correct, but contain semantic flaws. For example, if the candidate model is a decision tree, then one may use knowledge about the correct structure and behaviour of decision trees to check for internal consistency. In this case, we could represent the consistency checking criteria as a set of MODEL CHECKING RULES. For example, if the text describes the results of a trial of a treatment, and the representation of knowledge extracted from the text is a decision tree, then one could use simple mathematical checks to ensure the tree is meaningful. In this example, we could utilise knowledge about the way a trial is described as producing a number of different outcomes, such as patient responded to treatment, patient didn't respond, or patient had a side effect from treatment. A decision tree would need to account for all patients in the trial, and not double count patients into different arms of the decision tree, or omit them. For example, if 200 patients enter the trial at the top of the decision tree, then allowing for dropouts from the trial, the final branches of each arm of the decision tree generated must account for all patients. Such consistency checking would detect trees that were assembled which had more patients in the outcome arms than had enrolled in the trial, or too few patients. A plurality of such checking rules may be used. Different model representations would use different model checking rules. For example, a Bayesian net might utilise rules describing the laws of probability and Bayes' theorem to check for model consistency, and a model comprised of qualitative differential equations would be checked for consistency with mathematical laws and operations. As before, this filtering step removes candidate models that do not satisfy one of a possible plurality of satisfaction criteria. For example, a criterion may be that a candidate model must not fail even one model-checking rule. The actual criteria for matching the model checking rules and candidate models can vary, depending upon the noise in the text data, and the degree of match may be tailored to be very tight or quite loose, depending upon the domain of application. At the completion of this step, every member of the candidate model list has been tested, and we retain only those candidate models that have satisfied the satisfaction criteria for matching text rules to the document text.
10. Some trees may contain repairable flaws. A set of rules may be built that identify methods for repairing flaws identified in the previous stage. For example, a tree could have the correct number of participants at the entry and leaf nodes of the tree, but contain an error at a middle layer causing it to fail a previous model-checking rule. A repair rule may seek to remove the incorrect middle node which contains the wrong number of patients and identify a relationship which has the same concepts, but the correct number of patients in it. A knowledge base of MODEL REPAIR RULES may be of use where there is ‘noise’ in the text data, leading to improperly formed models. Such rules might be used to replace a faulty model element with a correct one, or to infer a plausible correct model element.

It is also possible that the errors or omissions identified by the MODEL CHECKING RULES originate from the text itself. Consequently the decision models generated here may be used to identify errors or omissions in the original text. A text that only produces flawed models can be flagged as requiring attention or revision.

The output of the system is a set of candidate models which have been extracted from the text, and are considered to be plausible representations of the knowledge previously encoded in the text, but now represented in a more computationally tractable form) and available for use both by humans and computational systems for tasks such as decision making and integration of the knowledge in multiple texts into a common model.

11. The process may be iterated by repeating the model assembly tasks with the models generated from a plurality of texts. For example, the integration of models from multiple texts may utilise knowledge represented as rules in a database of KNOWLEDGE SYNTHESIS rules. For example, decision trees from multiple clinical trial texts could be assembled using rules from statistical met-analysis, to pool the number of patients in multiple trials into a single decision tree that represents the collective knowledge across a plurality of related trials, described in different texts.

### Case Study

A worked case study will now be described to illustrate operation of the above described method. The example represents rules and data as Horn clauses, which are a form of logic representation used in programming languages such as Prolog.

### Stage 1—Text Analsyis

Text is input into the system, and then key concepts that appear in the text are extracted. Specifically, wherever a word or phrase appears in the text that can be matched to a word or phrase in the terminology system being used, then it is extracted, along with the concept types that the word might correspond to e.g.

Knowledge base=Medical terminology system like UMLS
Algorithm=any known text mark-up system eg MMTX. In this example the text mark up program produces a list of terms and their concepts in the following form:

Text=[Concept label, Concept Type].

### INPUT=

“A trial of Montelukast compared with salmeterol in protecting against asthma exacerbation in adults. Montelukast resolved asthma exacerbation in 100 of 120 patients and Montelukast caused skin rash in 20 of 120 patients. Salmeterol resolved asthma exacerbation in 80 of 120 patients and Salmeterol caused headache in 40 of 120 patients”

### OUTPUT=

‘Montelukast’=[‘montelukast’, ‘Organic Chemical, Pharmacologic Substance’].
‘with salmeterol’=[‘salmeterol’, ‘Organic Chemical, Pharmacologic Substance’].
‘asthma exacerbation’=[‘Asthma’, ‘Disease or Syndrome’], [‘Exacerbated’, ‘Qualitative Concept’].
‘in adults’=[‘adults’, ‘Age Group’].
‘skin rash’=[‘skin rash’, ‘Disease or Syndrome’].
‘headache’=[‘headache’, ‘Disease or Syndrome’].

### Stage 2—Text Transformation

STEP 1: Take the list of outputs from before, and see what possible relationships might exist between them
Knowledge base=list of known relationships; rules constraining what concepts can appear in each relationship

### Example List of Relationships:

treats(X, Y).
outcome(X, Y).

### Example of Constraint Rules:

| | |
|---|---|
| treats(X,Y) if | X = concept_type(′Organic Chemical,Pharmacologic |
| | Substance′) and |
| | Y = concept_type(‘Disease or Syndrome’). |

This rule says a drug can treat a disease

| | |
|---|---|
| outcome(X,Y) if | X = concept_type(′Organic Chemical,Pharmacologic |
| | Substance′) and |
| | Y = concept_type(‘Disease or Syndrome’). |

This rule says that the outcome of giving a drug might be a side-effect ie another disease

| | |
|---|---|
| outcome(X, | if X = concept_type(‘Organic Chemical,Pharmacologic |
| resolution) | Substance’). |

This says that the outcome of giving a drug might be a resolution of a disease
OUTPUT=a list of all the possible relationships that exist between the concepts previously extracted, using the relationships we know, limited by the need to satisfy at least one constraint rule i.e.
treats(montelukast, Asthma).
treats(salmeterol, Asthma).
treats(montelukast, skin rash).
treats(salmeterol, skin rash).
treats(montelukast, headache).
treats(salmeterol, headache).
outcome(montelukast, Asthma).
outcome(salmeterol, Asthma).
outcome(montelukast, skin rash).
outcome(salmeterol, skin rash).
outcome(montelukast, headache).
outcome (salmeterol, headache).
outcome(montelukast, resolution).
outcome (salmeterol, resolution).
Step 2: Remove Candidate Relationships which are not Supported by Evidence from the Text
Knowledge base=rules seeking evidence of relationship in text
Examples of text rules:
outcome(X, Y) if “X caused Y”.
This side-effect rule says if we can find a text string with the concept X and Y separated by the word caused then this is evidence that one is the outcome of the other.
outcome(X, resolution) if “X resolved Y”.

This rule says if we can find a text string with the concept X and Y separated by the word resolved then this is evidence that resolution of the disease is the outcome of treatment by X.

### OUTPUT=

treats(montelukast, Asthma).
treats(salmeterol, Asthma).
outcome(montelukast, skin rash).
outcome (salmeterol, headache).
outcome(montelukast, resolution).
outcome (salmeterol, resolution).
Strike though indicates these relationships were deleted by application of the rules.

### Step 3

Identify number of patients who had a given outcome, by use of text processing rules.
Knowledge-base=rules seeking evidence of outcome numbers in text
Examples of text rules:

outcome(X/B,resolution/A) if

outcome(X, resolution) and
“X resolved Y in A of B patients” and
number(A) and
number(B) and
A =< B.

This rule says if we find a text string with the numbers A and B associated with disease and treatment concepts we can infer numeric outcomes if A is less than or equal to B, because A would have to be a subset of the total number of patients B in the trial.

outcome(X/B,Y/A) if

outcome(X,Y),
“X caused Y in A of B patients” and
number(A) and
number(B) and
A =< B.

This rule says if we can find a text string with the numbers A and B associated with disease and treatment concepts we can infer numeric outcomes as long as A is less than or equal to B, because A would have to be a subset of the total number of patients B in the trial.

### INPUT=

treats(montelukast, Asthma).
treats(salmeterol, Asthma).
outcome(montelukast, skin rash).
outcome(salmeterol, headache).
outcome(montelukast, resolution).
outcome (salmeterol, resolution).

### OUTPUT=

treats(montelukast, Asthma).
treats(salmeterol, Asthma).
outcome(montelukast/120, skin rash/20).
outcome (salmeterol/120, headache/40).
outcome(montelukast/120, resolution/100).
outcome (salmeterol/120, resolution/80).

### Stage 3—Model Synthesis

In this stage we assemble the surviving relationships elements with numeric data into a model. In this example we chose to assemble these model elements into a decision tree, using rules that check to see that the tree is mathematically legal. An assembled tree would start with a parent node, then connect to two or more treatment branches, each connecting to one or more outcome branches.

Knowledge-base=tree assembly rules e.g

parent_node(Y) if treats (X, Y).

This rule says the tree starts with parent node which contains a disease concept.

treatment_branch(X, Y) if treats (X, Y).
This rule says that we look for branches from the parent node which contain treatments of a disease.
outcome_branch(X, Y) if outcome(X, Y).
This rule says that we look for branches from any treatment branch which describe outcomes of the treatment in the treatment branch.
We then write one or more rules that tries to assemble each of these individual components into a tree, starting with a parent node, and then looking for treatment branches that might plausible connect to the parent node, and then for outcome branches that might connect to the treatment branches, always looking to ensure that tree is consistent both conceptually as well as mathematically e.g.

| | |
|---|---|
| assemble tree ( | parent_node(Y/N5), |

[treatment_branch(X,Y),
outcome_branch(X/N1,O1/M1),
outcome_branch(X/N2,O2/M2)],
[treatment_branch(Q,Y),
outcome_branch(Q/N3,O3/M3),
outcome_branch(Q/N4,O4/M4)])
if

parent_node(Y) and
treatment_branch(X,Y) and
treatment_branch(Q,Y) and
outcome_branch(X/N1,O1/M1) and
outcome_branch(X/N2,O2/M2) and
outcome_branch(Q/N3,O3/M3) and
outcome_branch(Q/N4,O4/M4)]) and
N1 = N2 and
N3 = N4 and
N1 = M1 + M2 and
N3 = M3 + M4 and
N5 = N1 + N3.

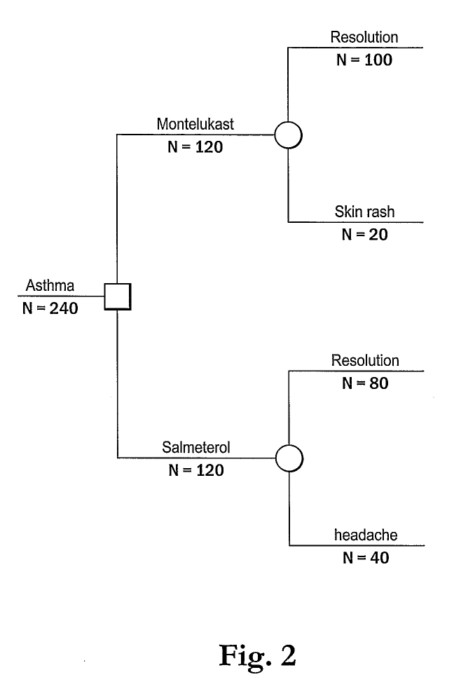

This is a simple rule for example purposes only, for assembling a 3-stage tree starting with a disease, moving to two treatment branches and then two outcome branches per treatment branch. The tree is assembled as a list in the head of the rule.
The rule also checks to see that both outcomes of a treatment add up to all the patients on the treatment eg that we have 120 people in total treated in the montelucast branches. More complex and flexible algorithms would be used to allow for a plurality of possible tree configurations.
Clearly many potential trees connecting relationships elements generated in earlier stages of the process will not satisfy the rule and be filtered. A visual representation of a tree that matches this rule from the above examples is shown in FIG. 2.
Referring to FIG. 2, it can be seen that the method described above has produced a machine readable decision tree from the paragraph of input text.
In the above embodiment, the domain concerned is medical literature. It will be appreciated that the present invention is not limited to application only in the medical domain. It may be applied in any other scientific or non-scientific domain. For example, it may be applied in the domain of chemical literature, biotechnological literature, or legal literature (e.g. case law) or any other domain.
Where methods and apparatus of the present invention may be implemented by software applications, or partly implemented by software, then they may take the form of program code stored or available from computer readable media, such as CD-ROMS or any other machine readable media, the program code comprising instructions which, when loaded onto a machine such as a computer, the machine then becomes an apparatus for carrying out the invention. The computer readable media may include transmission media, such as cabling, fibre optics or any other form of transmission media.
It will also be appreciated that, where methods and apparatus of the present invention are implemented by computing systems, or partly implemented by computing systems, then any appropriate computing system architecture may be utilised. This will include stand-alone computers, networked computers, and dedicated computing devices. Where the terms “computing system” and “computing device” are used, then these terms are intended to cover any appropriate arrangement of computer hardware for implementing the function described.
Any reference to prior art contained herein is not to be taken as an admission that the information is common general knowledge, unless otherwise indicated.
Finally, it is to be appreciated that various alterations or additions may be made to the parts previously described without departing from the spirit or ambit of the present invention.

1. A method of summarizing knowledge from a text, the method comprising:
determining at least two concepts from the text;
generating a set of candidate relationships between the concepts;
generating a set of relationships based on the set of candidate relationships according to predetermined criteria; and
generating, in an electronic device, a decision model based on the set of relationships.

2. A method according to claim 1, wherein determining the concepts from the text further comprises identifying terms in the text and determining concepts for at least some of the terms.

3. A method according to claim 2, wherein identifying the terms in the text comprises searching the text for terms matching a pre-defined set of terms.

4. A method according to claim 1, wherein determining the concepts comprises looking up possible concepts from a look up table of terms and concepts.

5. A method according to claim 1, wherein generating the set of candidate relationships is based on relationships that are common to the field of the subject matter to which the text relates.

6. A method according to claim 1, wherein generating the set of relationships comprises removing a candidate relationship that is implausible according to relationship constraint rules.

7. A method according to claim 1, wherein generating the set of relationships comprises retaining a candidate relationship that is supported by evidence in the text.

8. A method according to claim 1, wherein generating the set of relationships comprises modifying a candidate relationship if it is determined to be incorrect.

9. A method according to claim 1, wherein generating the set of relationships comprises inferring a candidate relationship if it is determined to be missing.

10. A method according to claim 1, further comprising testing the decision model for internal consistency.

11. A method according to claim 1, further comprising combining the decision model with other decision models derived from other texts.

12. A computer system configured to conduct a method according to claim 1.

13. A computer program arranged to cause a computing system to conduct a method according to claim 1.

14. A system for summarizing knowledge from a text, the system comprising:
determining means for determining some concepts from the text;
means for generating a set of candidate relationships between the concepts;
means for generating a set of relationships based on the set of candidate relationships according to predetermined criteria; and
means for generating a decision model based on the set of relationships.

15. A system in accordance with claim 14, wherein the determining means is configured to identify some terms in the text and determine concepts for at least some of the terms.

16. A system in accordance with claim 15, wherein the determining means is configured to identify terms in the text by searching the text for terms matching the predefined set of terms.

17. A system in accordance with claim 14, further comprising a look-up table of terms and concepts, and wherein the determining means is configured to look up possible concepts from the look-up table.

18. A system in accordance with claim 14, wherein the means for generating a set of committed relationships is configured to determine the relationships from relationships that are common to the field of the subject matter to which the text relates.

19. A system in accordance with claim 14, wherein the means for generating the set of relationships is configured to remove a candidate relationship that is implausible according to relationship constraint rules.

20. A system in accordance with claim 14, wherein the means for generating the set of relationships is configured to retain a candidate relationship that is supported by evidence in the text.

21. A system in accordance with claim 14, wherein the means for generating the set of relationships is configured to modify a candidate relationship if it is determined to be incorrect.

22. A system in accordance with claim 14, wherein the means for generating the set of relationships is configured to infer a candidate relationship if it is determined to be missing.

23. A system in accordance with claim 14, further comprising a testing means for testing the decision model for internal consistency.

24. A system in accordance with claim 14, further comprising combination means for combining the decision model with other decision models derived from other texts.

25. (canceled)

26. (canceled)
